(19) United States
(12) Patent Application Publication
(10) Pub. No.: US 2019/0324858 A1
(43) Pub. Date: Oct. 24, 2019

(54) ROLLBACK RECOVERY FROM PARTIAL FAILURE IN MULTIPLE ELECTRONIC CONTROL UNIT OVER-THE-AIR UPDATES

(71) Applicant: GM GLOBAL TECHNOLOGY OPERATIONS LLC, Detroit, MI (US)

(72) Inventors: Susanta P. Sarkar, Rochester Hills, MI (US); Kenneth P. Orlando, Sterling Heights, MI (US); Riley S. McGarry, Shelby Township, MI (US)

(21) Appl. No.: 15/960,941

(22) Filed: Apr. 24, 2018

(51) Int. Cl. G06F 11/14; G06F 8/65; H04L 29/08

(52) U.S. Cl. CPC G06F 11/1433; G06F 2201/865; H04L 67/34; G06F 8/65

(57) ABSTRACT

A system, computer-program product and computer-implemented method of updating a software configuration of a vehicle. A communication interface communicate with a plurality of electronic control units (ECUs) of the vehicle, and a processor. The processor performs an updating operation on the plurality of ECUs to change the software configuration for the plurality of ECUs from a first software configuration to an intended software configuration, identifies at least one ECU from the plurality of ECUs that fails to update to the intended software configuration after performing the updating operation. The processor rolls back the at least one successfully updated ECU to the previous version of software configuration.

The subject disclosure relates to a system and method of updating a software configuration of an electronic control unit or set of electronic control units used in vehicles and, in particular, for a system and method for rolling back software configurations in electronic control units that fail to successfully update during an update operation.

Vehicles include electronic control units (ECUs) that run software in order to operate various features of the vehicle. In order to maintain the vehicle with respect to current conditions, it is useful to update the software within an ECU from its current software configuration to an intended new software configuration. Using over-the-air updating techniques, the updating process has the potential to fail to correctly update the software within an ECU or to leave the resulting configuration between the various vehicle ECUs incompatible with each other, thereby rendering the vehicle inoperable. Accordingly, it is desirable to provide a method for recovering the vehicle to an operable state of a plurality of ECUs when an updating process does not successfully update the plurality of ECUs.

### SUMMARY

In one exemplary embodiment, a computer-implemented method of updating a software configuration of a vehicle is disclosed. The method includes performing an updating operation on a plurality of electronic control units (ECUs) to change the software at the plurality of ECUs from a first software configuration to an intended software configuration, identifying one or more ECUs from the plurality of ECUs that have not been updated to the intended software configuration after the updating operation, and rolling back at least one successfully updated ECU to the first software configuration.

In addition to one or more of the features described herein, the method includes performing the updating operation having as a result a post-update software configuration that is inoperable due to the failure of the at least one ECU to successfully update to the intended configuration. The method further includes determining a list of recoverable software configurations of the plurality of ECUs and changing the software configuration of the at least one successfully updated ECU to obtain a recoverable previous version of software configuration selected from the list.

In one embodiment, the recoverable previous version of software configuration is a software configuration that requires a change in configuration to a least number of the successfully updated ECUs. Changing the software configuration of the at least one ECU to obtain a second recoverable software configuration from the list when the at least one ECU cannot be changed to obtain the recoverable previous version of software configuration.

In one embodiment, the plurality of ECUs includes a subset of ECUs that can be rolled back, and the updating operation is performed on the subset of the plurality of ECUs. In addition, when the plurality of ECUs further includes a subset of ECUs that cannot be rolled back, the updating operation is performed on the subset of ECUs that cannot be rolled back after the subset of the plurality of ECUs that can be rolled back are in an operable configuration.

In another exemplary embodiment, a system for updating a software configuration of a vehicle is disclosed. The system includes a communication interface configured to communicate with a plurality of electronic control units (ECUs) of the vehicle, and a processor. The processor is configured to perform an updating operation on the plurality of ECUs to change the software configuration for the plurality of ECUs from a first software configuration to an intended software configuration, identify at least one ECU from the plurality of ECUs, wherein the ECU fails to update to the intended software configuration after performing the updating operation, and rollback the at least one successfully updated ECU to the previous version of software configuration.

In addition to one or more of the features described herein, in one embodiment, a post-update software configuration is inoperable due to the failure of the at least one ECU to successfully update to the intended configuration. The processor determines a list of recoverable compatible software configurations of the plurality of ECUs and changes the software configuration of the at least one successfully updated ECU to obtain a recoverable previous version of software configurations selected from the list.

In one embodiment, the recoverable previous version of software configuration is a software configuration that requires a change to a least number of successfully updated ECUs. The processor changes the software configuration of the at least one successfully updated ECU to obtain a second recoverable software configuration when the at least one successfully updated ECU cannot be changed to obtain the recoverable previous version of software configuration.

In one embodiment, the plurality of ECUs includes a subset of ECUs that can be rolled back and the processor performs the updating operation on the subset of the plurality of ECUs. In addition, when the plurality of ECUs includes a subset of ECUs that cannot be rolled back, the processor performs the updating operation on the subset of ECUs that cannot be rolled back after the subset of ECUs that can be rolled back are in an operable configuration.

In yet another exemplary embodiment, a computer-program product for updating a plurality of electronically controlled units (ECUs) is disclosed. The computer program product includes a computer readable storage medium having computer executable instructions stored therein. The computer readable storage medium includes instructions to perform an updating operation on the plurality of ECUs to change the software at the plurality of ECUs from an first software configuration to an intended software configuration, identify at least one ECU from the plurality of ECUs, wherein the ECU fails to update to the intended software configuration after performing the updating operation, and rollback the at least one successfully updated ECU to the first software configuration.

In addition to one or more of the features described herein, the computer-readable storage medium includes instructions to determine a list of recoverable software configurations of the plurality of ECUs and changes the software configuration of the at least one successfully updated ECU to obtain a recoverable previous version of software configuration from the list.

In one embodiment, the first recoverable software configuration is a software configuration that requires a change to a least number of the successfully updated ECUs. The computer-program product further includes instructions to change the software configuration of the at least one ECU to obtain a second recoverable software configuration from the list when the at least one successfully updated ECU cannot be changed to obtain the recoverable previous version of software configuration.

In one embodiment, the plurality of ECUs include a subset of ECUs that can be rolled back and the computer-readable medium includes instructions to perform the updating operation on the subset of ECUs. In addition, for when the plurality of ECUs includes a subset of ECUS that cannot be rolled by, the computer-readable medium further includes instructions to perform the updating operation on the subset of ECUs that cannot be rolled back after the subset of ECUs that can be rolled back are in an operable configuration.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustrative operating environment for remote update of vehicle ECUs through a wireless network, such as a mobile vehicle communication system;

FIG. 2 illustrates example components of the vehicle communication network that facilitate updating the vehicle ECUs in an efficient and flexible manner;

FIG. 3 shows a table of various ECU software configurations in order to illustrate a process of configuration rollback; and

FIG. 4 shows a flowchart illustrating a method of updating software on a plurality of vehicle ECUs in order to obtain an operable software configuration.

### DETAILED DESCRIPTION

The following description is merely exemplary in nature and is not intended to limit the present disclosure, its application, or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein facilitate remotely updating electronically controlled units (ECUs) in a vehicle in an efficient and flexible manner. Updating an ECU may include updating software that controls the ECU.

Updating one or more ECUs presents several obstacles. For example, the update depends on the owner bringing the vehicle to the dealer for the software update. The owner may not receive the notice of the update. The owner may skip a useful update due to the inconvenience, in time and effort, involved in taking the vehicle to the dealer.

Further, when updating any ECU, the update processes has to ascertain that the updated software version for the ECU is correct and compatible with the software versions present in other ECUs in the vehicle. For example, consider a vehicle that has a first ECU and a second ECU. If the first ECU is to be updated to a software version ECU1-1.1.2, the second ECU may be made compatible with software version ECU2-3.2.1 installed for the first ECU to operate properly. If the second ECU is using an older software version, such as ECU2-3.1.8, the second ECU must also be updated, before or at the same time, that the first ECU is updated to software version ECU1-1.1.2.

Accordingly, the technical solutions described herein update the ECUs by remote reflashing of software, for example through a wireless communication network, and overcome the above obstacles. The technical solutions also operate when the ECUs are updated in a wired manner, such as at a dealer/mechanic, where the vehicle may be connected to an updating device, such as a computer that contains an update package. Further, the technical solutions facilitate updating multiple ECUs in the vehicle in a single update session, thus reducing the time of installation. The technical solutions take into consideration the timing dependencies among the multiple ECUs during the software update installation. To this end, the technical solutions facilitate parallel installation of the updates, with serial capabilities in view of constraints, such as timing dependencies.

Another obstacle includes the partial or unsuccessful updating of ECUs during the updating operation, which can leave the ECUs in an inoperable condition. The methods disclosed herein provide a process for obtaining a recovered configuration when the unsuccessful updating of one or more ECUs occurs.

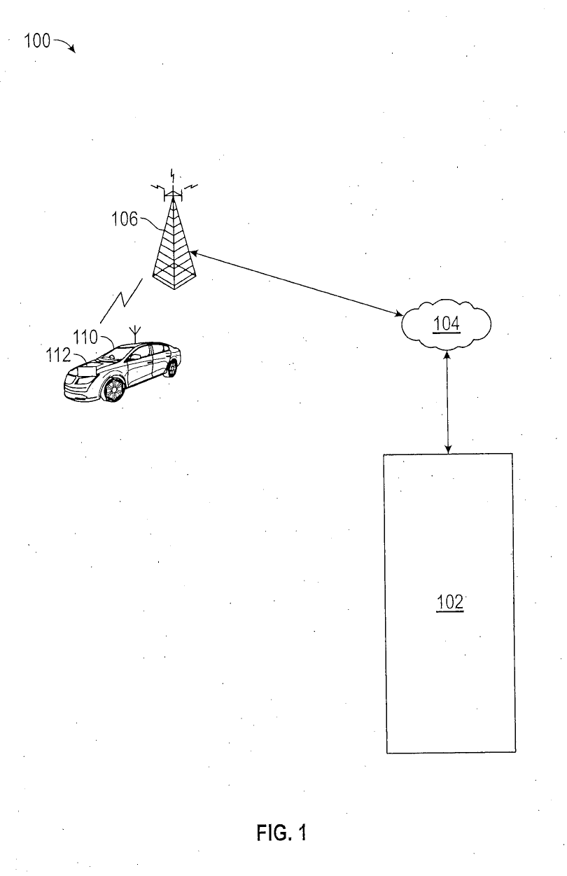

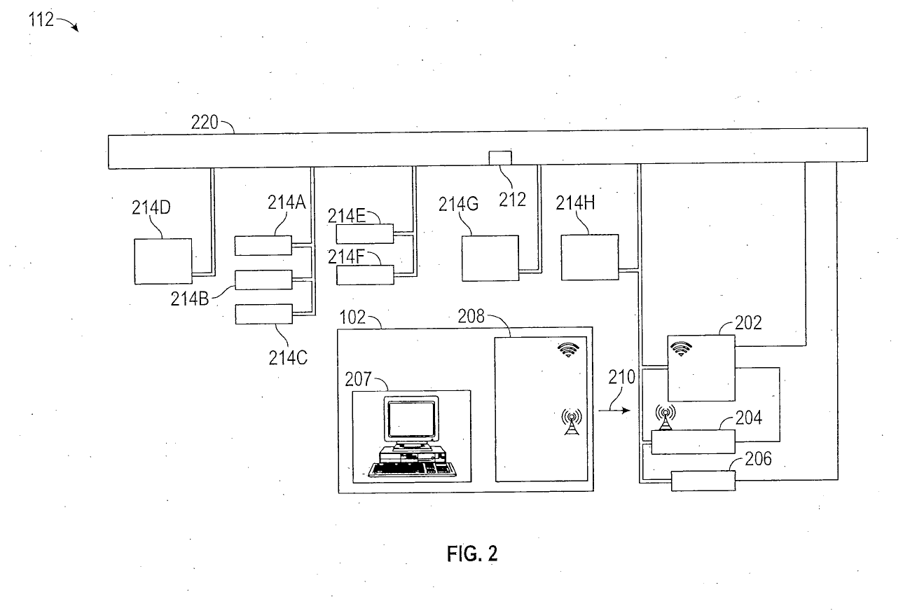

In accordance with an exemplary embodiment, FIG. 1 is an illustrative operating environment for remote update and reconfiguration of vehicle ECUs. The end-to-end mobile vehicle communication system 100 includes at least one mobile vehicle 110 including a vehicle communication network 112 (that includes a telematics device (204, FIG. 2)), one or more wireless carrier systems 106, one or more over-the-air communication networks 104 and one or more processing centers 102. In various embodiments, the end-to-end mobile vehicle communication system 100 utilizes a wireless network. The over-the-air communication network 104 can include services from one or more mobile telephone switching offices and wireless networks. The over-the-air communication network 104 can be implemented to form a suitable system for connecting wireless carrier system 106 to mobile vehicle 110 via any suitable wireless interface and/or standard. Data can be communicated bi-directionally between the processing center 102 and the mobile vehicle 110.

In one embodiment, mobile vehicle 110 is implemented as a vehicle equipped with a vehicle communication network 112 containing telematics device 204 for transmitting and receiving voice and data communications. The mobile vehicle 110 includes one or more electronically controlled units (ECUs) (214A-H, FIG. 2) having the capability of updating and/or reconfiguring their software.

In one embodiment, the one or more processing centers 102 can initiate an update and/or reconfiguration to software of one or more ECUs of the mobile vehicle 110. In alternate embodiments, the mobile vehicle 110 can send a signal or a service request to the one or more processing centers 102 to request a software update or a reconfiguration.

The mobile vehicle 110 can initiate a service request to the processing center 102 by sending a voice or digital signal command to telematics device (204, FIG. 2), which, in turn, sends an instructional signal or a voice call via wireless carrier system 106 and over-the-air communication network 104 to processing center 102. Also, one or more triggers stored in a reflash master 212, such as a number of ignition cycles or a specific time and day, can cause the mobile vehicle 110 to initiate the service request.

Processing center 102 contains one or more processors or communication services managers that provide automated or human-assisted service requests to the telematics device 204 of the mobile vehicle 110. In one embodiment, the processing center 102 is a telematics call center that facilitates communications to and from telematics device 204. In particular, the processing center 102 provides information needed for updating various ECUs of the mobile vehicle 110. This information includes but is not limited to control signals, data for updating the software configuration of the ECUs involved in the update, and/or performing a recovery operation on an ECU when the updating procedure fails or is partially-completed, as discussed herein.

It is noted that additional communication channels other than those shown in FIG. 1 can be used alternatively or in addition to the communication channel of FIG. 1. While multiple communication channels can exist between the processing center 102 and the mobile vehicle 110, a disruption along any one of these communication channels can cause a software update to be unsuccessful or partially-completed and thus requiring a recovery process to be initiated.

FIG. 2 shows a detailed view of the vehicle communication network 112 of the mobile vehicle 110. The vehicle communication network 112 includes a plurality of ECUs 214A-H and various communications devices. A gateway 220 provides wired communication channels between the ECUs 214A-H and the various communication devices. The ECUs 214A-H are responsive to driver demands and vehicle conditions to control operation of various vehicles systems, such as power train systems, body control systems, antilock braking systems, etc. Each of ECUs 214A-H stores software for its particular vehicle system so as to perform its particular function. Typically the ECUs 214A-H include a processor for executing software as well as memory for storing software and data. In one embodiment, the memory includes flash memory that can be erased and rewritten to store new software which includes operation control software and calibration files.

In one embodiment, the communication devices include a WiFi communication device 202, a telematics device 204 and other user interfaces 206. The processing center 102 includes communication devices 208 compatible with the mobile vehicle's 110 telematics device 204 for appropriate data transfer from a processor 207 within the processing center 102 to the various vehicle ECUs 214A-H.

The updating process is discussed with respect to the subset of ECUs 214A-C for illustrative purposes. In the illustrative embodiment, the telematics device 204 receives an update package 210, for updating one or more of the ECUs 214A-C, from the processing center 102 over one or more of the communication device 202 and telematics device 204. For illustrative purposes only, one embodiment of the update package 210 is provided to update ECUs 214A-C. The update package 210 contains update sub-packages for each of the ECUs 214A-C that are to be updated. Contents of the update package 210 can be subject to various constraints. For example, the update sub-packages for each of the ECUs 214A-C may be of different sizes. Thus, installing each of the update sub-packages may take different durations and different utility programs to facilitate the individual ECU updates. Additionally, the order of updating the ECUs 214A-C may affect operation of the ECUs 214A-C and the mobile vehicle 110. Also, the update package 210 may further contain sub-package(s) for ECUs coupled via other branches of the vehicle communication network 112. Furthermore, updating an ECU may include multiple parts, for example a first part and a second part, where the second part has to be installed after installation of the first part is complete. Accordingly, the update sub-packages are to be installed according to a priority order that facilitates the ECUs 214A-C to continue operating without performance penalties.

In an illustrative embodiment, the reflash master 212 determines an installation order for the multiple ECUs 214A-C and installs the sub-packages from within the update package 210 in a parallel/serial manner based on the constraints. The reflash master 212 further provides an update report to the processing center 102 indicating a successful update or partially-successful update and the resulting software configuration after of the update operation is completed. In various embodiments, the configuration of each ECU can be enumerated as either, “Unchanged after attempt to update”, “Intended Configuration after update”, or “Non Functional after attempt to update”. When an ECU, or set of ECUs, fails to update its software configuration or partially-updates its software configuration, the reflash master 212 can report this state of the ECU to the processing center 102. The reflash master 212 can also perform restorative or recovery operations on the particular, partially-updated ECU or set of ECUs and provide details of the recovery operation to the processing center 102.

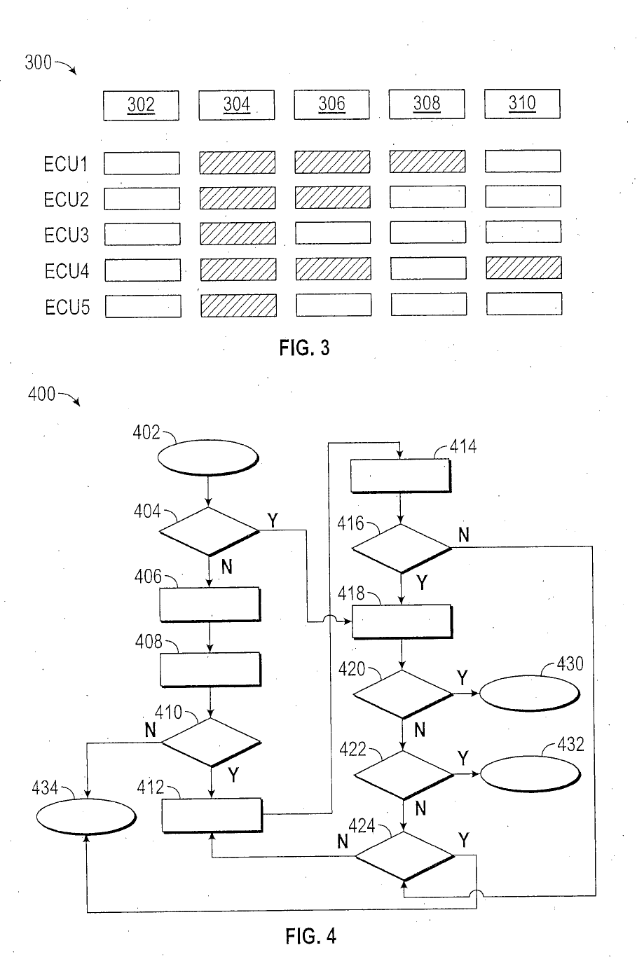

FIG. 3 shows a table 300 that contains various ECU software configurations in order to illustrate an example of a compatibility matrix or acceptable software configuration list for rollback. Rollback may be required when a software update at an ECU is unsuccessful in order to recover the ECU from an inoperable state. In order to make the ECU operable again, the software is “rolled back” to its previous software configuration. In another embodiment, a software operation can be performed on a plurality of ECUs, with some of the ECUs updating successfully and the other ECUs remaining in their original state. Based on incompatibilities of the updated software at one ECU with the original software at another ECU, this post-update configuration can leave the overall software configuration of the plurality of ECUs inoperable.

The example in table 300 includes five columns (302, 304, 306, 308 and 310), each column representing an ECU software configuration for each of the five ECUs (ECU1, . . . , ECU 5). The selection of five ECUs is for illustrative purposes only. It is to be understood that the vehicle can include any number of ECUs. The first column 302 represents a first software configuration for the ECUs that exists immediately prior to performing the software update process. The open boxes for ECU1, . . . , ECU5 represent the original, or first, configuration for each of the ECU5. The second column 304 represents an intended final configuration of the ECUs immediately after successfully performing the software update process. The hashed boxes for ECU1, . . . , ECU5 represent an intended, or successfully-updated, configuration for each of the ECUs. The third column 306 represents a post-updated configuration of the ECUs that occurs after performing an incomplete software update process. Not all of the ECUs have been successfully updated. In the event that the post-update configuration (column 306) is not the same as the intended final configuration (column 304) as shown, i.e., the post-update configuration includes one or more ECUs that failed to successfully update their software configurations, then the method proceeds to find a recovery software configuration of the ECUs that will operate. Achieving the recovery software configuration can include rolling back one or more of the ECUs back into their first or original software configuration. For illustrative purposes, the post-update configuration includes three ECUs (ECU1, ECU2 and ECU4) that were successfully updated and two ECUs (ECU3 and ECU5) that failed to successfully update and therefore remain in an original software configuration (i.e., equivalent to their state previous to performing the software update process).

The fourth column (308) and fifth column (310) show compatible software configurations that include at least one successfully updated ECU and that are operable as possible recovery configurations. Column 308 shows an operable recovery software configuration that includes one ECU (ECU1) that is operating in a successfully updated software state as well as four ECUs (ECU2, ECU3, ECU4 and ECU5) that are in their original software state. The recovery software configuration of column 308 can be obtained by rolling back each of ECU2 and ECU4 to their first software configurations. Column 310 shows an operable recovery software configuration that includes one ECU (ECU4) that is operating in a successfully updated software state as well as four ECUs (ECU1, ECU2, ECU3 and ECU5) that are in their original software state. The recovery software configuration of column 310 can be obtained by rolling back each of ECU1 and ECU2 to their first software configurations.

In various embodiments, the reflash master 212 performs an update operation on the ECUs in their first software configuration (column 302). After the update operation has been performed the ECUs are in a post-update configuration (column 306). The reflash master 212 determines or selects an acceptable recovery software configuration such as one of the software configurations shown in column 308 and 310 and rolls back individual ECUs into their state previous to performing the software update process in order to obtain the selected acceptable recovery software configuration. In various embodiments, the reflash master 212 updates the ECUs in steps, starting with ECUs that have the ability to be rolled back to their original software configuration and finishing with ECUs that do not have the ability to be rolled back.

FIG. 4 shows a flowchart 400 illustrating a method of updating software on a plurality of ECUs in order to obtain an operable software configuration. In an embodiment, the plurality of ECUs includes a first subset of ECUs that can be rolled back and a second subset of ECUs that cannot be rolled back. In various embodiments, the first subset of ECUs that can be rolled back is a proper subset of the plurality of ECUs.

In box 402, an update operation is performed (from a first software configuration) on those ECUs that can be rolled back, i.e., rollback capable ECUs. In box 404, the method checks to see whether all of the rollback capable ECUs have been successfully updated to their intended final states. If the rollback capable ECUs have been successfully updated, the method proceeds to box 418, which is discussed later. However, if the rollback capable ECUs have not been successfully updated, the method moves to box 406 where the recovery process begins.

At box 406, one or more recovery configurations for the ECUs is obtained. In box 408, a list is made for each of the one or more recovery configurations. For a selected recovery configuration, the list includes those ECUs that are to be rolled back in order to obtain the recovery configuration. In box 410, the method checks to see if a list is available; or if there is not a list, meaning that there are no recovery configurations available. If there is no list, the method proceeds to box 434 which indicates the update was unsuccessful. The indication of an unsuccessful update can be provided to the processing center 102. However if there is a list, the method proceeds to box 412. At box 412 an acceptable software configuration list is selected from the one or more lists available; the selected list requiring rollbacks on a least a number of ECUs. In box 414, rollback is performed on each of the ECUs in the selected acceptable software configuration list.

In box 416, a decision is made to determine whether the rollback of the ECUs was successful. If the rollback is not successful, the method proceeds to decision box 424 in order to determine if there is another acceptable software configuration list that can be tried. If all of the potential lists have been tried, there are no other acceptable software configuration lists available and the method proceeds to box 434 which indicates the update was unsuccessful. Otherwise, if the rollback is determined to be successful, the method proceeds to box 418. In box 418 an attempt is made to update all of the ECUs that were not capable to be rolled back, but that are also required to be in a successful state. In box 420, a decision is made as to whether the state of the ECUs after the operation of box 418 is as intended. If the combined state is as intended, the method proceeds to box 430 which indicates a successful software configuration. The indication of a successful software configuration can be provided to the processing center 102. If the combined state is not as intended, the method proceeds to box 422.

At box 422, a decision is made as to whether the combined state of ECUs is one of the acceptable recovery software configurations. If yes, the method proceeds to box 432 which indicates that a recovery of the software configuration is successful. The indication of a successful recovery, as well as the resulting software configuration can be provided to the processing center 102. Otherwise, if the combined state of the ECUs is not one of the acceptable recovery software configurations, the method proceeds to box 424. Box 424 is a decision box that determines if all of the lists have been tried. If they have all been tried, then the method proceeds to box 434, which indicates the update was unsuccessful. The indication of an unsuccessful update can be provided to the processing center 102. However, if not all of the software configuration lists have been tried the method returns to box 412 so that another software configuration list can be selected and another attempt to recover is tried.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A computer-implemented method of updating a software configuration of a vehicle, comprising:
performing an updating operation on a plurality of electronic control units (ECUs) to change the software at the plurality of ECUs from a first software configuration to an intended software configuration;
identifying one or more ECUs from the plurality of ECUs that have not been updated to the intended software configuration after the updating operation; and
rolling back at least one successfully updated ECU to achieve a first recovery software configuration.

2. The computer-implemented method of claim 1, wherein performing the updating operation results in a post-update software configuration that is inoperable due to the failure of the at least one ECU to successfully update to the intended configuration.

3. The computer-implemented method of claim 1, further comprising selecting the first recovery software configuration from a plurality of possible software configurations.

4. The computer-implemented method of claim 3, wherein the first recovery software configuration is selected from the plurality of possible recovery software configurations by requiring rollback to a least number of the successfully updated ECUs.

5. The computer-implemented method of claim 4, further comprising selecting a second recovery software configuration when the at least one successfully updated ECU fails to roll back to achieve the first recovery software configuration and rolling back the at least one successfully updated ECU to obtain the second recovery software configuration.

6. The computer-implemented method of claim 1, wherein the plurality of ECUs includes a first subset of ECUs that can be rolled back and a second subset of ECUs than cannot be rolled back, the method further comprising performing the updating operation on the first subset of ECUs.

7. The computer-implemented method of claim 6, further comprising performing an updating operation on the second subset of ECUs after the first subset of ECUs have been rolled back to achieve the first recovery software configuration.

8. A system for updating a software configuration of a vehicle, comprising:
a communication interface configured to communicate with a plurality of electronic control units (ECUs) of the vehicle; and
a processor configured to:
perform an updating operation on the plurality of ECUs to change the software configuration for the plurality of ECUs from a first software configuration to an intended software configuration;
identify at least one ECU from the plurality of ECUs, wherein the ECU fails to update to the intended software configuration after performing the updating operation; and
rollback the at least one successfully updated ECU to achieve a first recovery software configuration.

9. The system of claim 8, wherein the post-update software configuration is inoperable due to the failure of the at least one ECU to successfully update to the intended configuration.

10. The system of claim 8, wherein the processor is further configured to select the first recovery software configuration from a plurality of possible recovery software configurations.

11. The system of claim 10, wherein the processor is further configured to select the first recovery software configuration from the possible software configurations by requiring a change to a least number of the successfully updated ECUs.

12. The system of claim 10, wherein the processor is further configured to select a second recovery software configuration when the at least one successfully updated ECU fails to roll back to achieve the first recovery software configuration and to roll back the at least one successfully updated ECU to obtain the second recovery software configuration.

13. The system of claim 8, wherein the plurality of ECUs include a first subset of ECUs that can be rolled back and a second subset of ECUs than cannot be rolled back and the processor is further configured to perform the updating operation on the first subset of ECUs.

14. The system of claim 13, wherein the processor is further configured to perform an updating operation on the second subset of ECUs after the first subset of ECUs have been rolled back to achieve the first recovery software configuration.

15. A computer-program product for updating a plurality of electronically controlled units (ECUs), the computer program product comprising a computer readable storage medium, the computer readable storage medium comprising computer executable instructions, wherein the computer readable storage medium comprises instructions to:
perform an updating operation on the plurality of ECUs to change the software at the plurality of ECUs from an first software configuration to an intended software configuration;
identify at least one ECU from the plurality of ECUs, wherein the ECU fails to update to the intended software configuration after performing the updating operation; and
rollback the at least one successfully updated ECU to achieve a first recovery software configuration.

16. The computer-program product of claim 15, further comprising instructions to select the first recovery software configuration from a plurality of possible software configurations.

17. The computer-program product of claim 16, wherein the first recovery software configuration is selected from the plurality of software configurations by requiring a rollback for a least number of the successfully updated ECUs.

18. The computer-program product of claim 15, further comprising instructions to select a second recovery software configuration when the at least one successfully updated ECU fails to roll back to achieve the first recovery software configuration and to roll back the at least one ECU to obtain the second recovery software configuration.

19. The computer-program product of claim 15, wherein the plurality of ECUs include a first subset of ECUs that can be rolled back and second subset of ECUs that cannot be rolled back, further comprising instructions to perform the updating operation on the first subset of ECUs that can be rolled back.

20. The computer-program product of claim 19, further comprising instructions to perform an updating operation on the second subset of ECUs after the first subset of ECUs have been rolled back to achieve the first recovery software configuration.
